(19) United States
(12) Patent Application Publication
(10) Pub. No.: US 2024/0351733 A1
(43) Pub. Date: Oct. 24, 2024

(54) STRETCH-BLOW-MOLDED PLASTIC CONTAINER AND METHOD FOR PRODUCING SAME

(71) Applicant: ALPLA Werke Alwin Lehner GmbH & Co. KG, Hard (AT)

(72) Inventors: Christian ZMÖLNIG, Schwarzach (AT); Adem DEMIR, Lauterach (AT); Danilo GRIECO, Feldkirch (AT)

(73) Assignee: ALPLA Werke Alwin Lehner GmbH & Co. KG, Hard (AT)

(21) Appl. No.: 18/684,282

(22) PCT Filed: Aug. 26, 2022
(86) PCT No.: PCT/EP2022/073748

§ 371 Date: Feb. 16, 2024

(30) Foreign Application Priority Data
Aug. 27, 2021 (CH) 070211/2021

(51) Int. Cl. B65D 1/02; B29C 49/12; B29C 49/48; B29K 67/00; B29L 31/00; B65D 23/10

(52) U.S. Cl. CPC B65D 1/0223; B29C 49/4812; B65D 23/102; B29C 49/12; B29K 2067/003; B29L 2031/7158

(57) ABSTRACT

The invention relates to a stretch-blow-molded plastic container (100) with a container body (20), which forms a filling volume (F), and a handle (21), which is formed on the container body. In order to form the handle (21), a first sub-region (221) of a first wall (22) of the container body (20) is bonded to a second sub-region (231) of a second wall (23) of the container body (20) lying opposite the first wall (22). The filling volume (F) extends circumferentially about the bonded connection. A bead (31) made of melted material is arranged within the filling volume between the first wall (22) and the second wall (23).

The present invention relates to a stretch-blow-molded plastic container and a method for producing a bead made of melted material according to the preamble of the independent claims.

Many plastic containers are known from the prior art.

Various methods are known for the production of plastic containers, in particular plastic bottles, the application of said methods also being dependent, not least, on the plastics used. Usually, the plastic containers are produced in a blow-molding process in which plastic containers, for example plastic bottles, are inflated into their final shape by positive pressure in a blow mold. In the case of blow molding, different process techniques are distinguished, of which in particular the extrusion blow-molding process, the injection blow-molding process, and the injection stretch blow-molding process should be mentioned. In the extrusion blow-molding process, a single-or multi-layer plastic hose is extruded hot, introduced into a blow mold, and inflated to form a plastic container via a blowing mandrel introduced into a mold cavity of the blow mold. The injection blow-molding process is a combination of injection molding and blow molding. In this case, a preform is first produced in an injection-molding process in an injection mold. The preform is demolded from the injection mold, optionally conditioned, and introduced into the mold cavity of a blow mold, in which it is finally inflated with overpressure in accordance with the shape predetermined by the mold cavity. In the injection stretch blow-molding method, the preform introduced into the mold cavity is additionally stretched with a stretching mandrel during the blow-molding process. The inflation of the preform can be carried out directly after its production in the injection-molding method. In alternative production methods, the further processing of the preforms can also take place spatially and/or temporally separately from the production of the preform. Finally, it should also be mentioned that the preforms can also be produced in an extrusion process or also in an extrusion blow-molding process.

In addition, plastic containers which have an integral handle have become known, and it has been found that plastic containers have higher acceptance among the users when the plastic containers have a handle which is offset from the rest of the container and which can be completely grasped by the hand. A relatively simple solution for providing such handles is achieved in that the plastic container has a reach-through opening passing through a container body.

WO 2017/211540 A1 discloses a plastic container, in particular made of PET, which has a reach-through opening and a corresponding handle. The reach-through opening of the plastic container of WO 2017/211540 A1 is obtained in that, after the stretch blow-molding of the plastic container, two wall parts are welded together, and then a corresponding region separated by the weld seam is cut out of the container.

A comparable plastic container made of polypropylene has become known with EP 1 835 461 A2.

Both plastic containers have a connection seam lying in the reach-through opening. Under certain circumstances, this can form a weak point on the plastic container, which can be disadvantageous in particular in the mail-order sector in which the handling of the products cannot be fully monitored and these products are loaded above their permitted limits time and time again.

It is therefore the object of the invention to overcome at least one or more disadvantages of the prior art. In particular, a plastic container which is stable and withstands higher loads is to be provided.

This object is achieved by the devices and methods defined in the independent claims. Further embodiments emerge from the dependent claims.

A device according to the invention relates to a stretch-blow-molded plastic container having a container body which forms a filling volume. The plastic container has a handle which is formed on the container body. In order to form the handle, a first sub-region of a first wall of the container body is integrally connected to a second sub-region of a second wall lying opposite the first wall, such that the filling volume extends peripherally around this integral connection. In other words, a single, continuous filling volume is created within the container body.

A bead made of melted material is arranged within the filling volume between the first wall and the second wall.

The arrangement of a bead between the first wall and the second wall makes it possible to reduce a notch effect occurring at the connection between the first wall and the second wall. This makes the plastic container more stable and less vulnerable to impacts.

The bead can be part of a weld seam. An integral connection can thus be created between the bead, the first wall and the second wall and accordingly the weld seam.

The bead can connect the first wall and the second wall in a region in which the first wall and/or the second wall has a curvature.

In regions in which the walls have curvatures, the walls are particularly susceptible to peeling under the action of force from the outside.

By the arrangement of a bead in this region, the corresponding effects can be reduced, which overall leads to a higher stability of the plastic container.

The bead can connect the first wall and the second wall in a region in which the first wall is spaced apart from the second wall.

Likewise in regions in which gaps or spacings are formed between the walls to be connected, a corresponding connection between these walls is more vulnerable to external influences, in particular more vulnerable to the action of force. By providing a bead in the region of a spacing between the first wall and the second wall, in particular in the region of a gap, susceptibility to failure of the container can be counteracted.

The bead preferably projects, toward the filling volume, beyond the surfaces of the first wall and of the second wall that face the filling volume.

By means of such an arrangement, a recess or a notch between the first wall and the second wall can be completely prevented and the connection of the first wall and the second wall in this region can be strengthened.

Preferably, the bead is formed peripherally along the first sub-region and/or the second sub-region.

In other words, the bead forms a peripheral closed connection between the first wall and the second wall. A corresponding gap between the first wall and the second wall is thus closed in relation to the filling volume.

The first sub-region and the second sub-region can be severed on the side of the filling volume remote from the integral connection, so that a reach-through opening is formed.

The plastic container can be formed of a polymer having a dipole, in particular PET.

Such polymers are particularly well suited for high-frequency welding, since their molecules can be excited particularly well.

A further aspect of the invention relates to a method for producing a bead made of melted material between a first wall and a second wall of a container body, the second wall lying opposite the first wall. The method comprises the steps of:
providing a stretch-blow-molded plastic container having a container body which forms a filling volume,
integrally connecting a first sub-region of the first wall of the container body to a second sub-region of the second wall to form a handle formed on the container body, such that the filling volume extends peripherally around this integral connection.

The integral connection is created by high-frequency welding or friction welding. During the welding process, pressure is exerted on the welding zone so that at least a portion of the melt produced during the welding process is pressed out of the welding zone to form the bead.

High-frequency welding and friction welding are methods which allow the elements which are to be joined to be melted in the region of their contact. Due to the pressure exerted on the walls to be joined, the melt thus produced can be pressed outward from the interior or from the region between the first wall and the second wall so that a bead is formed which is an integral part of the weld seam and which accordingly has a correspondingly high strength together with the weld seam. Due to the occurrence as a melt, this bead can also connect to the regions of the first wall and of the second wall which, for example, do not lie exactly against one another and/or cannot be reached directly by the corresponding welding devices.

The melt is preferably pressed toward the filling volume.

Accordingly, the bead is also produced in the region of the container which is directed toward the filling volume and in which the first wall and the second wall meet.

At the same time, a portion of the melt is also pressed in the opposite direction, so that the first wall and the second wall also connect in regions which are remote from the filling volume.

The melt is preferably pressed out of the welding zone until a bead formed from the melt connects the first wall and the second wall in a region in which the first wall and/or the second wall has a curvature.

It can thereby be achieved that a gap between the first wall and the second wall is filled with a bead and a notch effect is reduced. The peeling off of the first wall from the second wall in the event of an excessive application of force can accordingly be prevented longer.

The melt is preferably pressed out of the welding zone until a bead formed from the melt connects the first wall and the second wall in a region in which the first wall is spaced apart from the second wall.

It can thereby be likewise achieved that a gap between the first wall and the second wall is filled with a bead and a notch effect is reduced. The peeling off of the first wall from the second wall in the event of an excessive application of force can accordingly be prevented longer.

It can be provided that the melt is pressed out of the welding zone until a bead formed from the melt projects, toward the filling volume, beyond the surfaces of the first wall and of the second wall that face the filling volume.

The surface of the first wall and the surface of the second wall and a surface of the bead form a common surface, which in particular is free of notches and/or recesses. Such a common surface is in particular less vulnerable to application of force and can withstand peeling processes for a long time.

Before the first sub-region is integrally connected to the second sub-region, the first sub-region and the second sub-region can be brought into contact with one another by means of movable dies within a blow mold.

This makes it possible to define the later shape of the plastic container within wide ranges and to correspondingly bring the sub-regions of the first wall and of the second wall which are to be joined into a shape that is advantageous for the welding process.

After the integral connection of the first sub-region and the second sub-region, the first sub-region and the second sub-region can be severed on the side of the filling volume remote from the integral connection, so that a reach-through opening is formed.

A container can thereby be created which is visually attractive and has a pleasant feel and has a handle that can be completely encircled by the user. Secure holding of the container is thereby enabled.

The invention is explained below by means of an exemplary embodiment, with reference to schematic figures. In the figures:

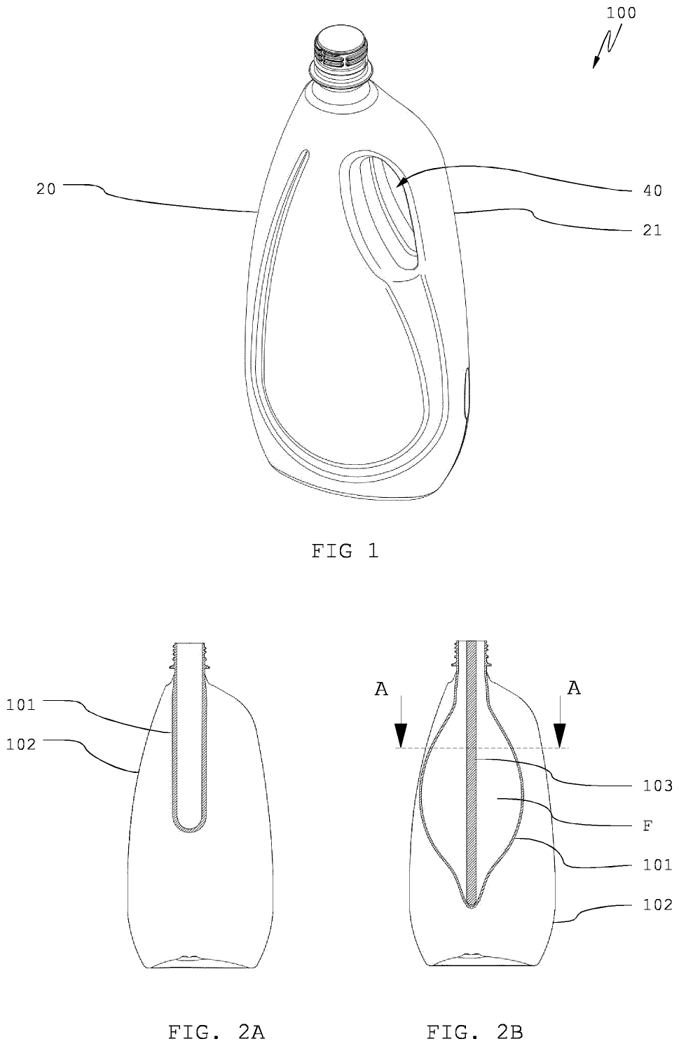

FIG. 1: shows a perspective view of a plastic container;

FIG. 2A, 2B: show a schematic view of a blow molding process;

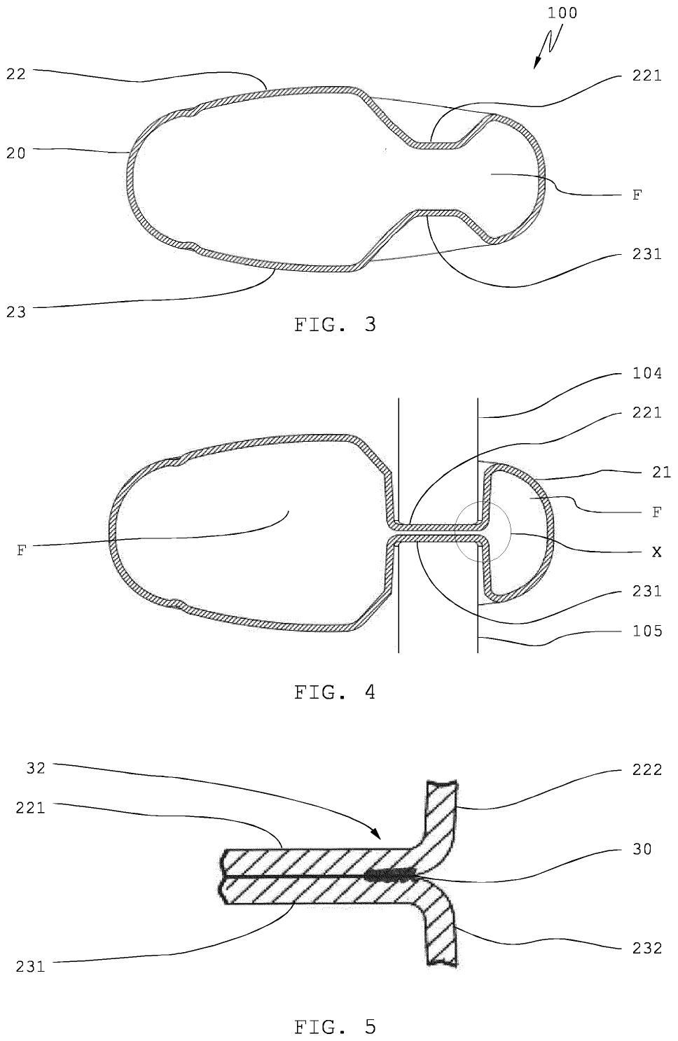

FIG. 3: shows a sectional view through a plastic container;

FIG. 4: shows a sectional view through a plastic container;

FIG. 5: shows a detail view from FIG. 4;

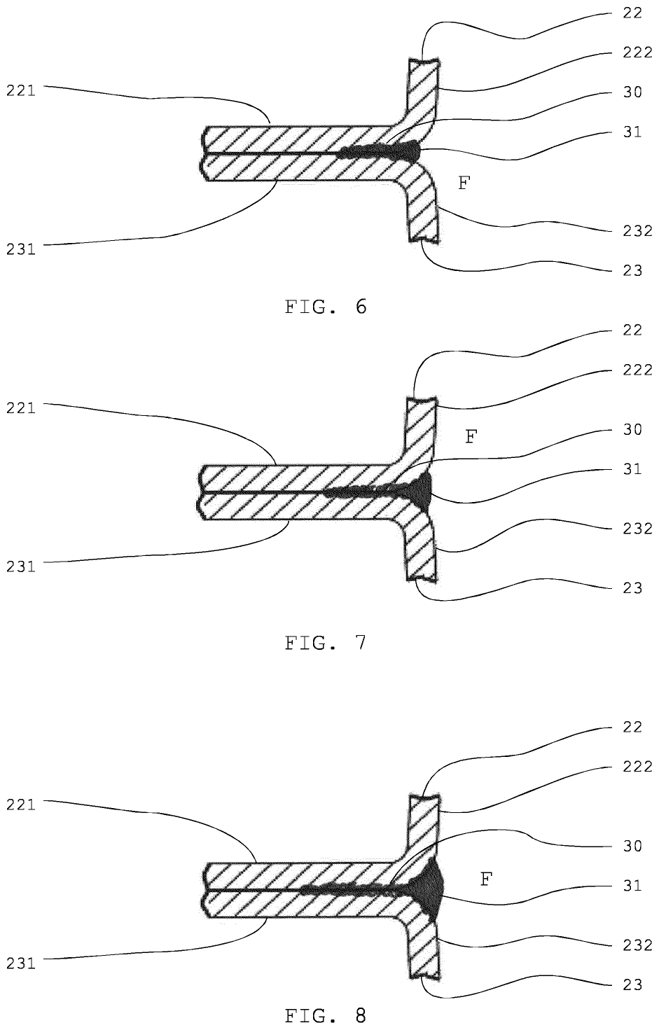

FIG. 6: shows the detail view from FIG. 5;

FIG. 7: shows the detail view from FIG. 5;

FIG. 8: shows the detail view from FIG. 5.

FIG. 1 shows a plastic container 100 having a container body 20 and a handle 21. The handle 21 is an integral part of the container body 20. The plastic container 100 has an upper opening, which is not described in more detail, and a container bottom opposite from this opening. The container bottom and the opening terminate the container body 20.

The container grip 21 is arranged such that it can be completely encircled. For this purpose, a reach-through opening 40 is provided on the container body 20. A filling volume extends around the reach-through opening 40. The filling volume fills the container body 20 and the handle 21. In other words, the interior of the handle 21 is connected to the filling volume.

FIGS. 2A and 2B show a blow molding process schematically. A preform 101 is introduced into a mold 102. At this point in time, the preform 101 is already temperature-controlled. The mold 102 essentially has the later outer contour of the plastic container. As can be seen in FIG. 2B, for the inflation of the preform a stretch rod 103 is introduced into the preform 101 and the preform 101 is stretched accordingly. At the same time, a hot blowing medium is blown into the preform 101 with positive pressure, so that the preform can come into contact with the inner surfaces of the blow mold 102.

FIG. 3 shows a cross-section along the line A-A of FIG. 2B, the cross-section being shown in chronological sequence following the complete inflation of the container 100. The container body 20 has a first wall 22 and a second wall 23 lying opposite the first wall 22. The first wall 22 has a sub-region 221 which is shaped toward the interior of the container body 20 in relation to an envelope. The second wall 23 also has a sub-region 231 which is shaped toward the interior of the container body 20 in relation to an envelope. The contour of the cross-section shown in FIG. 3 can be created by the blow mold 102 and the corresponding inflation. The sub-regions 221 and 231 are spaced apart from one another, so that the region of the subsequent handle, on the right in the present figure, can also be completely inflated. The walls 22 and 23 delimit a filling volume F.

FIG. 4 shows a cross-section analogous to the cross-section according to FIG. 3. FIG. 4 shows that the sub-regions 221 and 231 are shaped by means of dies 104 and 105 so that these sub-regions 221 and 231 are brought into contact with one another. This process preferably can be carried out so long as the inflated container is still within the blow mold. This makes it possible to maintain, for example, a positive pressure within the filling volume F so that the walls of the container body are pressed against the inner surfaces of the blow mold so that the rest of the contour of the container body remains correspondingly shaped. The filling volume F is still formed within the handle 21 and within the rest of the container body 20.

FIG. 5 shows a detail view X from FIG. 4. In this detail view, a portion of the first sub-region 221 and a portion of the second sub-region 231 are illustrated. The sub-regions 221 and 231 are brought into contact with one another and are in particular prepared for subsequent welding. The sub-regions 221 and 232 transition into the walls 22 and 23, respectively.

The sub-regions 221 and 231 are connected to one another by high-frequency welding. Two electrodes, not presented in more detail here, press the sub-regions 221 and 231 together, so that material lying therebetween is melted. The region which is pressed together is referred to in the present case as a welding zone 32. This refers to a region which is directly acted upon by the electrodes. The melting creates a weld seam 30. The mutually contacting surfaces of the sub-regions 221 and 231 thus soften in the region of the welding zone and a melt is produced which forms a weld seam. The electrodes press the sub-regions 221 and 231 together at high pressure. On the right in the illustration according to FIG. 5, the sub-regions 221 and 231, or the walls 22 and 23, each have a curvature in the region in which the handle 21 (see FIG. 4) widens. In the region of this curvature, the surfaces 222 and 232 of the walls 22 and 23 begin to distance from one another, so that a gap is created.

FIG. 6 shows a detail view corresponding to FIG. 5 at a later point of the method. Due to the pressure applied by the electrodes, at least a portion of the melt is pushed out of the weld seam 30, in particular out of the welding zone 32 (see FIG. 5), toward the filling volume F, so that a bead 31 forms between the first wall 22 and the second wall 23. A joining zone can thereby also be created in a region which cannot be directly acted upon by the electrodes. The distance between the weld seam 30, and in the present case the bead 31, and a force application point at the walls 22 or 23 is reduced. The connection can thereby withstand higher loads.

As illustrated in FIG. 6, the welding process can also be continued further. The bead 31 then fills a gap created by the curvature of the walls 22 and 23, and this directly leads to a reduction in the notch effect between the walls 22 and 23. The bead 31 closes the gap between the first wall 22 and the second wall 23 toward the filling volume. The bead 31 thus connects the first wall 22 and the second wall 23 in a region in which the first wall 22 and the second wall 23 have a curvature. In this region, the first wall 22 is likewise spaced apart from the second wall 23. The bead 31 thus connects the walls 22 and 23 in this region and bridges a gap between the first wall 22 and the second wall 23.

FIG. 7 shows a detail view corresponding to FIG. 6 at a later point of the method, if the method is continued even further. By further melting and by the pressure of the electrodes on the sub-regions 221 and 231, the melt was pressed to both sides of the original weld seam 30 (see FIG. 5). Due to the present arrangement of the walls 22 and 23 and the corresponding sub-regions 221 and 231, a large part of the melt of the weld seam 30 has been pressed toward the open side of the gap between the first wall 22 and the second wall 23 and accordingly toward the filling volume F. The bead 31 nearly fills the gap between the first wall 22 and the second wall 23. The notch effect which occurs due to the present geometry is further reduced, since the attack surface and the recesses in the region of the gap are reduced. The bead 31 nearly fills the gap toward the filling volume F.

FIG. 8 shows a detail view corresponding to FIG. 7 at a later point of the method, if the method is continued even further. By further melting and by the pressure of the electrodes on the sub-regions 221 and 231, the melt was pressed out even further to both sides of the original weld seam 30 (see FIG. 5). The bead 31 formed here projects beyond the surfaces 222 and 232 of the walls 22 and 23 that face the filling volume F so that the walls 22 and 23 are strengthened in the region of the gap and thus in the region of their curvature.

All embodiments of the weld seam 30 and of the bead 31, as described with respect to FIGS. 6 to 8, reinforce the connection between the walls 22 and 23 and increase the strength of the connection and in particular reduce the susceptibility to failure. As a result of impacts against the plastic container, the pressure within the filling volume F can become relatively high. Due to the reduced notch effect and the filling of the gap with the bead 31, the influence of such impacts on the weld seam 30, as well as on the connection between the first wall 22 and the second wall 23, can be reduced.

Of course, the bead 31 can in each case be formed peripherally around the sub-regions 231 and 221 and accordingly terminates them in relation to the filling volume F. The associated weld seam 30 thus forms a continuous, peripheral termination of the sub-regions 221 and 231 in relation to the container body 20. The weld seam forms an integral connection. The first sub-region 221 and the second sub-region 231 can be severed on the side of the filling volume remote from the integral connection, so that a reach-through opening 40 is formed (see FIG. 1).

1. A stretch-blow-molded plastic container (100) having a container body (20), which forms a filling volume (F), and a handle (21), which is formed on the container body, wherein, in order to form the handle (21), a first sub-region (221) of a first wall (22) of the container body (20) is integrally connected to a second sub-region (231) of a second wall (23) of the container body (20) lying opposite the first wall (22), such that the filling volume (F) extends peripherally around this integral connection, wherein a bead (31) made of melted material is arranged within the filling volume (F) between the first wall (22) and the second wall (23).

2. The plastic container (100) according to claim 1, wherein the bead (31) is part of a weld seam (30).

3. The plastic container (100) according to claim 1, wherein the bead (31) connects the first wall (22) and the second wall (23) in a region in which the first wall (22) and/or the second wall (23) has a curvature.

4. The plastic container (100) according to claim 1, wherein the bead (31) connects the first wall (22) and the second wall (23) in a region in which the first wall (22) is spaced apart from the second wall (23).

5. The plastic container (100) according to claim 1, wherein the bead (31) projects, toward the filling volume, beyond the surfaces (222, 232) of the first wall (22) and of the second wall (23) that face the filling volume.

6. The plastic container (100) according to claim 1, wherein the bead (31) is formed peripherally along the first sub-region (221) and/or the second sub-region (231).

7. The plastic container (100) according to claim 1, wherein the first sub-region (221) and the second sub-region (231) are severed on the a side of the filling volume remote from the integral connection, so that a reach-through opening (40) is formed.

8. The plastic container (100) according to claim 1, wherein the plastic container is formed of a polymer having a dipole, in particular PET.

9. A method for producing a bead (31) made of melted material between a first wall (22) and a second wall (23) of a container body (20), the second wall lying opposite the first wall (22), comprising the steps of:
providing a stretch-blow-molded plastic container (100) having a container body (20) which forms a filling volume,
integrally connecting a first sub-region (221) of the first wall (22) of the container body (20) to a second sub-region (231) of the second wall (23) to form a handle (21) formed on the container body (20), such that the filling volume extends peripherally around this integral connection,
wherein
the integral connection is created by high-frequency welding or friction welding, wherein pressure is exerted on a welding zone (32) during the welding process so that at least a portion of the melt produced during the welding process is pressed out of the welding zone (32) to form the bead (31).

10. The method according to claim 9, wherein the melt is pressed toward the filling volume.

11. The method according to claim 9, wherein the melt is pressed out of the welding zone (32) until a bead (31) formed from the melt connects the first wall (22) and the second wall (23) in a region in which the first wall (22) and/or the second wall (23) has a curvature.

12. The method according to claim 9, wherein the melt is pressed out of the welding zone (32) until a bead (31) formed from the melt connects the first wall (22) and the second wall (23) in a region in which the first wall (22) is spaced apart from the second wall (23).

13. The method according to claim 9, wherein the melt is pressed out of the welding zone (32) until a bead (31) formed from the melt projects, toward the filling volume, beyond the surfaces (222, 232) of the first wall (22) and of the second wall (23) that face the filling volume.

14. The method according to claim 9, wherein before the first sub-region (221) is integrally connected to the second sub-region (231), the first sub-region (221) and the second sub-region (231) are brought into contact with one another by means of movable dies (104, 105) within a blow mold (102).

15. The method according to claim 9, wherein after the integral connecting, the first sub-region (221) and the second sub-region (231) are severed on the a side of the filling volume (F) remote from the integral connection, so that a reach-through opening (40) is formed.
